(19) United States
(12) Patent Application Publication
(10) Pub. No.: US 2012/0042520 A1
(43) Pub. Date: Feb. 23, 2012

(54) CERAMIC TWIN KITCHEN KNIVES

(76) Inventor: Marc Daniel SIMERAY, Paris (FR)

(21) Appl. No.: 12/859,316

(22) Filed: Aug. 19, 2010

(51) Int. Cl. B26B 11/00

(52) U.S. Cl. 30/143

(57) ABSTRACT

The present invention pertains to a set of two uni-body ceramic kitchen knives, wherein the handle of each knife is designed with a longitudinal opening in order to receive the blade of the other knife, wherein the width of the resulting groove inside the handle allow the cleaning during a dish-washing machine cycle. The resulting assembly, fitting in Head-to-tail method, protects each edge of blade, and could be carried safety after use.

### FIELD OF THE INVENTION

The present invention relates to Kitchen knives and, more particularly, to a set of two uni-body ceramic kitchen knives designed to be washed safely in a dish-washing machine.

### BACKGROUND OF THE INVENTION

Ceramic Kitchen knives are now commonly used and appreciated for the durability and quality of their edge of the blade; However, as a consequence of the high hardness property of the zirconium ceramic, the low resilience of this material makes the edge of the blade a fragile area that has to be preserved from shocks with other cutlery to avoid chips. Therefore, ceramic knives cannot be washed in dish-washing machine cycle between other cutleries. Typically, the leaflet forbids such case of exposure. For a kitchenware, such restriction is an important limitation for the convenience of use.

The state of the art as disclosed in the patent DE 1992077 is a twin knife designed for trekking; each blade is longitudinally inserted upside down in the handle of the other that has a sheath especially designed for this.

This sheath protects the blade but this is not suitable for a kitchen use; the sheath cannot be cleaned properly inside, then the blade is not safe for food contact after. Any food particle could remain in the sheath; and rot inside; this may poison the user.

### DESCRIPTION OF THE INVENTION

It is therefore an object of the present invention to provide a set of two ceramic kitchen knives enhanced for dish-washing cycle.

It is a further object of the present invention to protect the edge of the blade from any chips, during the storage time in a drawer but not only, resulting by shocks with other cutlery.

The invention describes a set of two uni-body kitchen knives K1 and K2, with respectively the blades B1 and B2 in ceramic but not only, fitting in Head-to-tail method when it is coupled, wherein the edge of blade of a knife E1 (or E2) is respectively protected by the handle of the other knife H2 (or H1), wherein the resulting set of knives, assembled together, can be cleaned easily during dish-washing machine cycle;

As a primary feature of the invention, the bottom side of each handle is especially designed with a longitudinal opening (groove) G1 or G2, in order to receive the blade of the other knife, B2 or B1, sufficiently wide to allow the cleaning by water flow during dish-washing machine cycle. When a regular uni-body knife is typically full material at the handle for the mechanical resistance, the original design presents a substantially weaken structure at the handle in order to meet with the benefits of cleaning improvements. In a preferred embodiment, the dimensioning of the handle is appropriately sized to meet the requirements of resistance;

As a further feature of the invention, the design of the groove is enhanced with a plurality of perforations P1 and P2, in order to increase the water flow during cleaning. When external surface of a regular uni-body knife handle is closed area, the original design includes perforations at preferred location such as the neutral axis (neutral fiber) or extremity of the handle at top (opposite to the blade) to limit the stress value during use and the risk of breaking. Of course, in a non-preferred embodiment, it is contemplated that the handle could be designed without perforation;

As another feature of the invention, the assembly of the set of knives can be maintained by two magnets M1 and M2 inserted respectively in the handles H1 and H2 (Each magnet encapsulated in each handle), aligned together, close to the junction with the blade, where the magnetic strength attracts the both knives K1 and K2 together. Of course, in a non-preferred embodiment, it is contemplated that the knives could be assembled by various methods well-known by those of ordinary skill in the art without departing from the spirit and scope of the invention;

As an additional feature of the invention, the magnets M1 and M2 also authorize to fix the set of knifes assembled together on any magnetic steel surface as a solution of storage, preferentially for kitchen but not only;

As a feature of the invention, the handles H1 and H2 are made of plastic resin that resists in dish-washing machine temperature (about 75 Celsius degree) and the detergent;

As a feature of the invention, the magnets M1 and M2 likewise preferably are made of thermo-resistant material with strong magnetic force and high Curie point (Rare earth magnets from class of temperature M, H, SH, comply for repetitive exposure to cycle of dish-machine appliance).

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a front view of a schematic illustration of the set of two uni-body kitchen knives assembled together, in accordance with the present invention;

FIG. 2a, FIG. 2b, FIG. 2c are section views of FIG. 1, respectively according the section lines A-A, B-B C-C;

FIG. 3 is top view of FIG. 1;

FIG. 4 is a perspective showing the set of two uni-body kitchen knives separated, in accordance with the present invention;

FIG. 5 is a schematic illustration of the set of two uni-body kitchen knives in accordance with the preferred embodiment of the present invention;

FIG. 6 is a perspective view of FIG. 5;

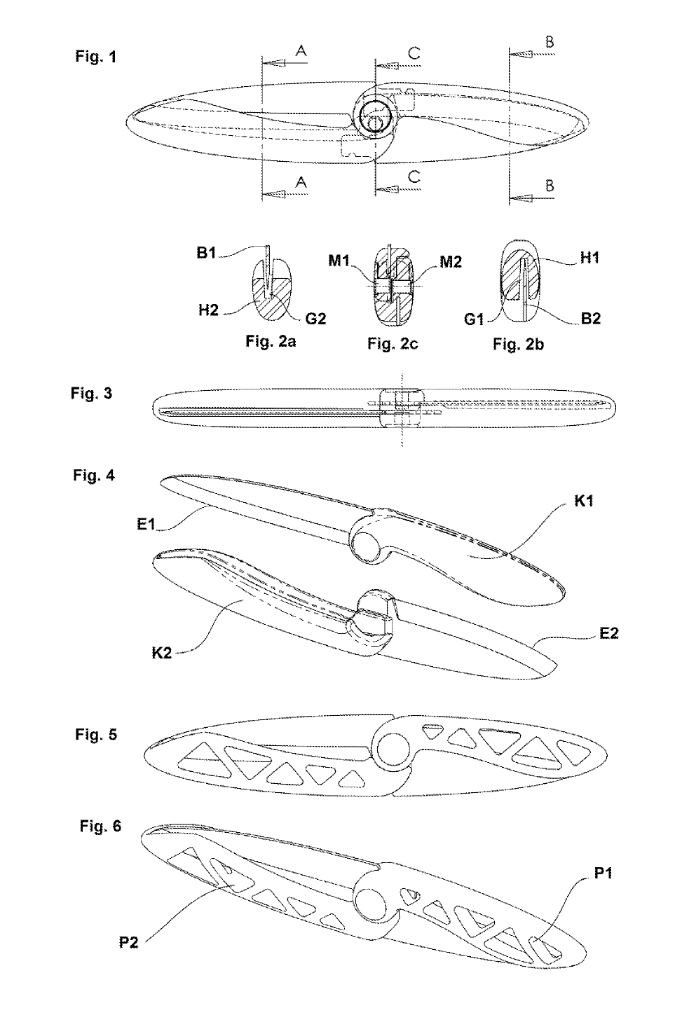

1) A set of kitchen ceramic knives comprising two uni-body knives, fitting in Head-to-tail method, wherein the said knife may be cleaned inside a dish-washing machine thanks to:
a handle of each knife designed with a wide longitudinal opening at bottom side in order to receive the edge of blade of the other knife, and to protect it from shocks;
The width of the resulting groove inside the handle that allow the cleaning including during a dish-washing machine cycle;

2) The set of two kitchen ceramic knives of claim one, wherein the handles includes perforations along the blade of the second knife when it is coupled, in order to improve the cleaning operation with regular water flow during cycle of dish-washing machine;

3) The set of two kitchen ceramic knives of claim one, wherein the assembly is maintained by magnetic strength through the handles with two magnets, one inserted on each handle close to the blade;

4) The set of two kitchen ceramic knives of claim one, wherein the assembly is maintained by another mechanical fixing solution.
